(19) United States
(12) Patent Application Publication
(10) Pub. No.: US 2026/0037634 A1
(43) Pub. Date: Feb. 5, 2026

(54) HARDWARE-PROTECTED SYSTEM MEASUREMENTS

(71) Applicant: Micron Technology, Inc., Boise, ID (US)

(72) Inventors: James Ruane, San Jose, CA (US); Jeffrey Munsil, Fort Collins, CO (US); Artsiom Zankovich, Milpitas, CA (US); Steven A. Schauer, Loveland, CO (US)

(21) Appl. No.: 18/791,028

(22) Filed: Jul. 31, 2024

(51) Int. Cl. G06F 21/57; H04L 9/32

(52) U.S. Cl. CPC G06F 21/575; H04L 9/3242; G06F 2221/034

(57) ABSTRACT

Devices and techniques that provide hardware-protected system measurements are described herein. A system comprises a memory device accessible by a first device and a host device, wherein the first device is configured for use with the host device; processing circuitry coupled to the memory device; and programmable read-only memory coupled to the memory device, the programmable read-only memory comprising instructions to: initialize the first device; validate firmware that is to execute on the first device; obtain a measurement of the firmware; store the measurement in the memory device; and initiate execution of the firmware.

### BACKGROUND

Memory devices are typically provided as internal, semiconductor, integrated circuits in computers or other electronic devices. There are many diverse types of memory including volatile and non-volatile memory. Volatile memory can require power to maintain data and includes random-access memory (RAM), dynamic random-access memory (DRAM), and synchronous dynamic random-access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random-access memory (RRAM), and magnetoresistive random access memory (MRAM), 3D XPoint™ memory, among others.

Memory cells are typically arranged in a matrix or an array. Multiple matrices or arrays can be combined into a memory device, and multiple devices can be combined to form a storage volume of a memory system, such as a solid-state drive (SSD), a Universal Flash Storage (UFS™) device, a MultiMediaCard (MMC) solid-state storage device, an embedded MMC device (eMMC™), etc., as discussed further below.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

To easily identify the discussion of any particular element or act, the most significant digit or digits in a reference number refer to the figure number in which that element is first introduced.

FIG. 1 is a block diagram illustrating a platform architecture of a system, according to an embodiment.

FIG. 2 is a block diagram illustrating a storage device, according to an embodiment.

FIG. 3 is a data and control flow diagram illustrating a more detailed version of a boot process, according to an embodiment.

FIG. 4 is a flowchart illustrating an example method for managing hardware-protected system measurements, in accordance with some embodiments.

FIG. 5 illustrates a block diagram of an example machine with which, in which, or by which any one or more of the techniques (e.g., methodologies) discussed herein can be implemented.

### DETAILED DESCRIPTION

Aspects of the present disclosure are directed to hardware-protected system measurements and using the measurements for authentication, attestation, security, and integrity. Security risks and threats are a constant challenge for companies that rely on information technology. While security risks exist at every level of a computing system, platform security is paramount to providing a bottom-up security model for the rest of the system. In a bottom-up security model, trust is rooted at the component level in the system and then other higher-layer elements of the system (e.g., firmware, operating system, user-domain software, etc.) can be authenticated, attested, and trusted as they initialize.

While some mechanisms are used to address platform security, they fall short of a complete solution. Many of the mechanisms require firmware interaction during a system boot. However, the firmware itself is an attack surface that may be exploited. Hence, there is a need for platform-level attestation and authentication that does not involve executing firmware.

The present systems and methods described herein provide for a secure platform that does not require the deployment of a communication infrastructure for platform components to establish a chain of trust. Instead, hardware measurements of various components are calculated and stored as reference values in registers. On system startup (boot), new measurements are calculated by each of the components, and the measurements are compared to the reference values to authenticate the corresponding components. Because the measurements are calculated at boot, they can be locked from device firmware access and made available to the host without device firmware interaction. Security is increased because there is no device firmware involved. For instance, malware inserted into device firmware cannot be used to spoof the measurement.

By avoiding use of device firmware for component attestation in a system, the system can ensure that the correct device firmware is executing, and that the system is correctly configured. Because the device firmware measurement is stored in a reference register, the device firmware itself can be measured and attested. This is an advantage over other systems that use signatures alone, which may indicate that the device firmware has been correctly signed but does not actually confirm that the device firmware has the correct contents. Additionally, the measurements can be exported to host-visible locations without device firmware interaction for interrogation by the host or other attestation processes. Additional details are set forth below.

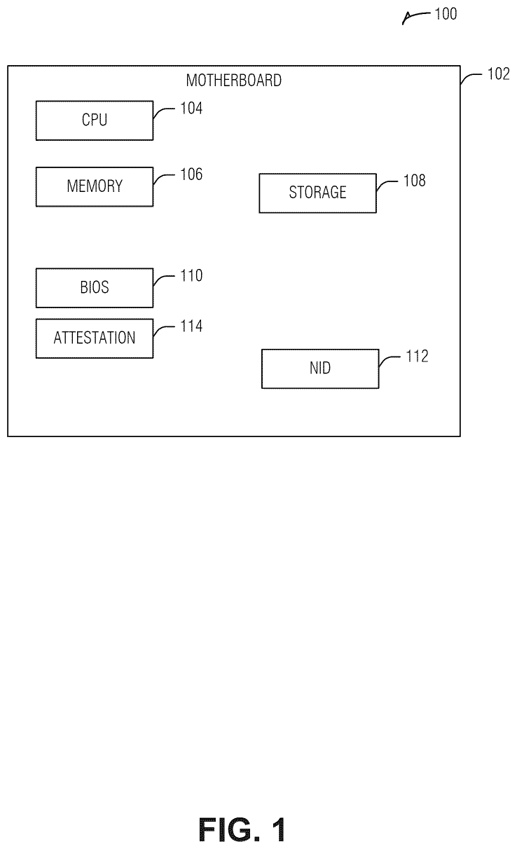

FIG. 1 is a block diagram illustrating a platform architecture 100 of a system, according to an embodiment. The platform architecture 100 may be embodied on a motherboard 102 (also referred to as a mainboard) with a central processing unit (CPU) 104, main memory 106, storage device 108, a basic input/output system (BIOS) chip 110, a network interface device 112, and attestation circuitry 114. Depending on the design and intended use of the motherboard 102, other elements may exist including power supply components; circuitry to connect main memory 106, PCI/PCIe, and other high-speed peripheral devices to the CPU 104 via the front-side bus (FSB) (e.g., northbridge, a memory controller hub (MCH), or integrated into the CPU 104); circuitry to connect sound card, hard drives, USB, SATA, and other slower-speed peripheral devices to the CPU 104 (e.g., southbridge, input/output controller hub, a platform controller hub (PCH), etc.); headers for power switches, audio, external USB ports, and lights; and PCI or PCIe slots for expansion cards. Such elements are not illustrated in FIG. 1 to streamline the discussion.

The motherboard 102 may be of various forms and sizes to be used in mobile devices, cellular phones, desktop computers, laptop computers, enterprise blade servers, televisions, network appliances (e.g., routers), automobiles, and the like.

The CPU 104 may be soldered onto the motherboard 102 in some embodiments, and in other embodiments, the CPU 104 may be connected to the motherboard using a socket or connector, such as a zero insertion force (ZIF) socket that uses either land grid array (LGA), pin grid array (PGA), or ball grid array (BGA) CPU packages.

The main memory 106 (also referred to as random access memory (RAM)) stores data temporarily during the normal operation of the system. The main memory 106 may be soldered directly to the motherboard 102 or may be connected using one or more memory slots (not shown). The memory slots may be configured to accept a specific type of memory module, such as 100-pin SDRAM, 168-pin SDRAM, 184-in DDR SDRAM, 240-pin DDR2/DDR3 SDRAM, 288-pin DDR4/DDR5 SDRAM, 144-pin SDR SDRAM, or the like.

The storage device 108 may be of various forms, such as a hard disk drive (HDD), solid-state drive (SSD), RAM drive, or the like, that is connected over a parallel ATA, Serial ATA, SCSI, Serial Attached SCSI (SAS), or Fibre Channel interface. The storage device 108 is non-volatile and as such, data persists even when the storage device 108 is not powered.

The BIOS chip 110 includes a non-volatile memory with firmware instructions and data used during the startup (boot) process of the system. Note that the older BIOS implementations have been replaced with Unified Extensible Firmware Interface (UEFI) implementations. For the purposes of this document, BIOS and UEFI are interchangeable. The BIOS chip 110 is activated as soon as the system is powered on and it executes a series of firmware instructions stored in its memory. The firmware instructions may perform system integrity checks, test hardware components, initialize system settings, and start the operating system by locating the Master Boot Record (MBR) and executing the platform bootloader.

The network interface device 112 (also referred to as a network interface controller) includes facilities to communicate over a wired or wireless network. The network interface device 112 may be provided in circuitry integrated into a CPU 104, in its own package on the motherboard 102, or on an expansion card. When the network interface device 112 is disposed on an expansion card, it may be referred to as a network interface card and be connected to the motherboard 102 using a PCI/PCIe expansion slot, for example.

The attestation circuitry 114 is used to provide an integrity check of components of the platform architecture 100. The attestation circuitry 114 may be an instance of a Trusted Platform Module (TPM) and may conform to the TPM 1.2 or TPM 2.0 specification provided by the Trusted Computing Group (TCG). The attestation circuitry 114 may be disposed in its own package on the motherboard 102 or integrated into another package on the motherboard 102 (e.g., as part of the BIOS chip 110).

The attestation circuitry 114 works with the BIOS chip 110 to perform integrity checks on one or more components of the platform architecture 100 (e.g., storage device 108, network interface device 112, etc.). These checks may be performed before firmware is executing on any of the components. This provides a higher level of trust of the system component because one is assured that the firmware, which may have been compromised, has not had an opportunity to modify the measurements. Once the firmware is authenticated, the attestation circuitry 114 is more assured that other features of the components can be used with a reasonable level of trust. The platform can hold up any communication with a device besides reading of measurements before its firmware is attested, after which the device firmware may be executed.

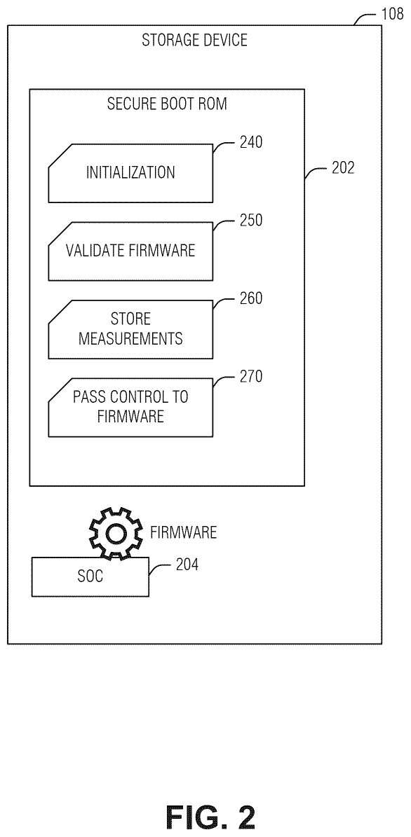

FIG. 2 is a block diagram illustrating a storage device 108, according to an embodiment. The storage device 108 may be a solid-state drive (SSD) that uses integrated circuit assemblies to store data. For example, the storage device 108 may be non-volatile memory that can provide persistent data storage using NAND flash memory.

The storage device 108 includes a secure boot ROM (read-only memory) 202 and a system-on-a-chip (SOC) 204. The SOC 204 is used to provide an execution environment for firmware. The SOC 204 may include a processing device, memory, registers, input/output facilities, and other circuitry (e.g., application specific integrated circuit (ASIC), accelerators, etc.) to provide the execution environment. During boot, the SOC 204 accesses the secure boot ROM 202 to obtain a device firmware image to execute. It is understood that the secure boot ROM 202 may be incorporated into the same package as the SOC 204. The secure boot ROM 202 may be implemented as a discrete silicon component in a single semiconductor package, an integrated component incorporated in one or more semiconductor packages, which may include other logic units in the same package(s), or as a firmware-based component running in a trusted execution environment (TEE) on a System-on-a-chip (SOC)

In an embodiment, the secure boot ROM 202 is implemented using a secure trusted environment, such as a Secure Execution Environment (SEE) or a Trusted Execution Environment (TEE). An SEE or TEE is a secure area that is used to provide confidential computing tasks, such as code signing, encryption, certificate signing, and the like. The SEE or TEE may include secured memory resources to provide isolated execution.

The secure boot ROM 202 may be implemented as a type of non-volatile memory chip (e.g., NOR-based flash device). The secure boot ROM 202 may be implemented as part of the SOC 204. The secure boot ROM 202 is immutable and contains a small set of instructions, often referred to as boot firmware or bootloader firmware, which is required to start up an electronic device (e.g., storage device 108). The primary purpose of the secure boot ROM 202 is to initialize the hardware components of the device and load the bootloader program into memory. The bootloader program then takes over the boot process, loading device firmware from memory devices in the secure boot ROM 202, or performing additional boot stages to execute the device firmware on the SOC 204.

A device firmware image is a snapshot or a package containing the software code and data that runs on embedded systems, such as SOCs, microcontrollers, hardware devices, or computer peripherals. It is essentially the operating system or control software for that specific piece of hardware. Firmware images include low-level code that controls the hardware directly, providing instructions for the device to function properly. These images can be updated or replaced to fix bugs, add features, or enhance performance in the hardware they are designed for. In this case, the device firmware image is used to operate the storage device 108.

The initialization operation 240 checks and initializes the hardware components. Then, circuitry in the secure boot ROM 202 validates one or more firmware images (operation 250) and stores measurements of the firmware images (operation 260). The measurements may be requested later by an attestor circuit (e.g., attestation circuitry 114) on a host of the storage device 108 to verify the integrity of the storage device 108 before allowing the firmware (e.g., bootloader firmware, device firmware, etc.) on the storage device 108 to operate.

The measurements are stored in one or more registers in the SOC 204. The registers may be hardware registers on the SOC 204 or storage device 108, or logical registers in RAM on the storage device 108 or main memory 106, or a mixture of both types (hardware and logical registers). The registers may be referred to as platform configuration registers (PCRs). Two or more PCRs may be organized as a PCR bank. Various embodiments may use two or more PCRs to store measurements for different firmware images (e.g., bootloader firmware, device firmware, main firmware, etc.). The registers are locked after writing the measurements. In this way, the device firmware is not able to modify the measurements after starting up. Additionally, the host has read-only access to the measurements.

The host, via the attestor circuit, can interrogate the storage device 108 at one or more pre-specified addresses to obtain the measurements from the PCRs. Alternatively, the host can issue a request for measurements to the SOC 204 during normal operation of the storage device 108 after boot. The host, via the attestor circuit, can then compare the measurements obtained from the storage device 108 with expected values (e.g., a previous value of a measurement or an independently calculated value of a measurement) and based on a result of the comparison, permit or deny the remainder of the host platform to start up.

After the firmware is validated and measured (operations 250 and 260), the secure boot ROM 202 initiates execution of the device firmware and passes control to the device firmware (operation 270).

Note that while examples here describe use of the secure boot ROM 202, SOC 204, and other components in the context of a storage device 108 (e.g., an SSD drive), the security mechanisms described here may be used in any expansion card or expansion device including, but not limited to video cards, network interface cards, sound cards, external storage devices, or the like.

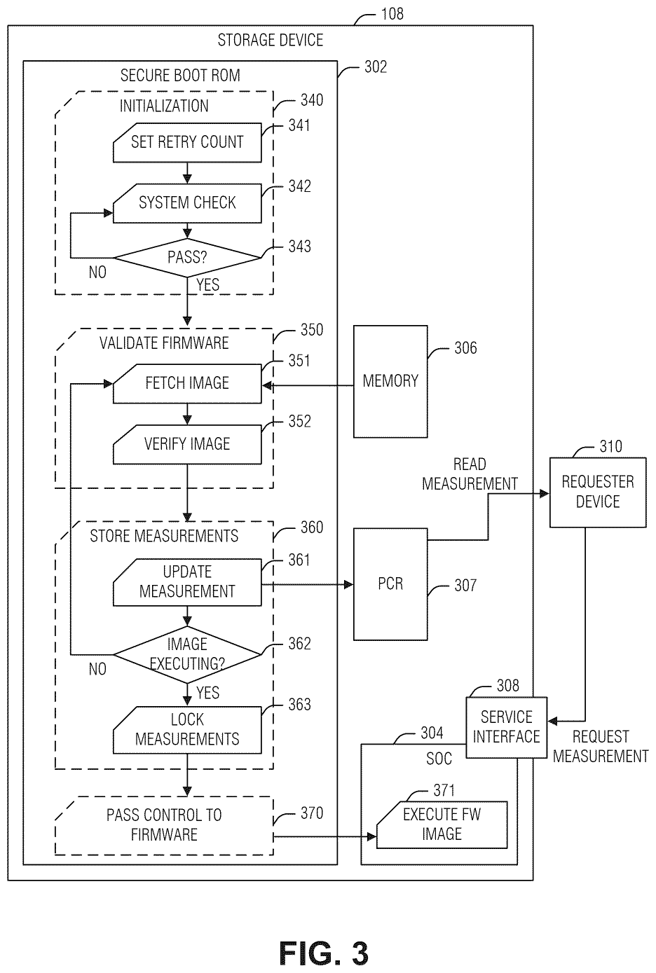

FIG. 3 is a data and control flow diagram illustrating a more detailed version of a boot process, according to an embodiment. As with the architecture and operations described in FIG. 2, the flow in FIG. 3 starts in the secure boot ROM 302 with the initialization operation 340. Here, the initialization operation 340 includes a set retry count sub-operation 341, a system check sub-operation 342, and a determination of whether the system check passed in sub-operation 343.

The set retry count sub-operation 341 is performed once and is used to set the maximum number of retries for the system check. This value is then decremented on each attempt to perform the system check sub-operation 342.

The system check sub-operation 342 is used to initialize and verify the state of the secure boot ROM 302 or its components. For example, the system check sub-operation 342 may check to ensure that platform configuration registers (PCRs) are cleared on first start up. The system check sub-operation 342 may also validate one or more keys that the secure boot ROM 302 uses for encryption operations. Encryption operations may include a random number generator, public-key cryptographic algorithms, cryptographic hash functions, symmetric-key algorithms, digital signature generation and verification, mask generation functions, and exclusive or functions. The system check sub-operation 342 may also initialize any verification, attestation, validation, or authentication circuitry that is used to analyze and ensure the integrity of firmware images.

If the system check sub-operation 342 does not pass, then it is executed again (retried) up to a number of retries set in the set retry count sub-operation 341. If the system check sub-operation 342 passes, then at determination sub-operation 343, the flow continues to the validate firmware operation 350.

The validate firmware operation 350 includes a fetch image sub-operation 351 and a verify image sub-operation 352. The fetch image sub-operation 351 obtains a firmware image from storage. The firmware image may be one of several that are verified during the validate firmware operation 350. Firmware images may include a bootloader firmware image, a secure execution environment (SEE) firmware image, a main firmware image, ACC firmware image (accelerator FW such as an embedded cryptographic accelerator), or the like. The firmware images may be stored in programmable ROM, non-volatile RAM (NVRAM), or hardcoded into one or more memory devices 306 on the storage device 108.

The verify image sub-operation 352 validates the integrity, provenance, and other aspects of the firmware image under test. This may be performed by validating a signature of the firmware image. The signature is an encrypted hash of the firmware image (e.g., code). The signature may be referred to as a message digest (e.g., the encrypted output of a hash function). The hash is encrypted using the private key of a firmware image provider to produce the signature. The corresponding public key of the firmware image provider may be part of the firmware image's data, delivered with the firmware image (e.g., as a separate value or file), or otherwise made accessible to the secure boot ROM 202.

The verify image sub-operation 352 may include circuitry or instructions to calculate a hash of the firmware image to obtain a calculated hash value. Using a public key provided with the firmware image, the firmware image signature is decrypted, producing a decrypted hash value. The calculated hash value is compared with the decrypted hash value to verify authenticity of the firmware image. The hash algorithm used to encrypt the hash value may be Secure Hash Algorithm 1 (SHA-1), SHA-256, SHA-512, or the like.

If an image is unable to be verified, the boot process may abort. Other remedial operations may be used, such as error logging, user notification, or the like. If the verification is successful, then the store measurements operation 360 is initiated. The store measurements operation 360 includes an update measurement sub-operation 361, an image executing check 362, and a lock measurements sub-operation 363.

In the update measurement sub-operation 361, one or more measurements of the firmware image are obtained. Measurements may include data such as a software version, a firmware version, a firmware image signature, a hash of a block or several blocks of executable instruction (e.g., a hash of a secure boot ROM boot block or a SOC boot block), or the like. The measurement may be hashed with a private key assigned to the secure boot ROM 302 to produce a secure measurement. In various implementations, the (raw) measurement or the secure (hashed) measurement may be stored in one or more PCRs 307. When multiple PCRs are used for a corresponding multiple firmware images, in an embodiment, the initial firmware image measurement (e.g., the bootloader firmware image) is used as a base to extend other firmware image measurements. For instance, the initial firmware image measurement may be concatenated with the device firmware measurement, and the concatenated value stored as the device firmware measurement.

At the image executing check 362, it is determined whether the firmware image being assessed is ready to be executed or is already executing. If this is so, then at lock measurements sub-operation 363, the PCRs 307 are locked (e.g., made read only).

If there are more images to validate, then the process returns to the fetch image sub-operation 351 to obtain the next image to assess. Otherwise, the control passes to firmware in operation 370.

When the SOC 304 is ready to execute firmware (e.g., bootloader firmware, main device firmware, etc.), then the SOC 304 may first check with the secure boot ROM to ensure that the firmware is validated. The memory devices 306 or PCR 307 may be accessed by the SOC 304 to obtain firmware images, measurements, public keys, or other information. The SOC 304 may independently obtain a measurement of the firmware under test, use a public key of the secure boot ROM to hash the measurement, and then compare the hashed measurement to the secure measurement stored in a PCR.

Additionally, other devices on the host, such as an attestor circuit (e.g., attestation circuitry 114), may interrogate the storage device 108 and evaluate whether firmware has been validated. A service interface 308 may be used by a requestor device 310 on the host. The requestor device 310 may request measurements from the storage device 108 via the service interface 308. Alternatively, the requestor device 310 may obtain measurements directly from PCRs. In either case, the requestor device 310 can then use these measurements in comparisons at the requestor device 310 to validate firmware or operating status of the storage device 108. In an embodiment, the storage device 108 is connected to the host via a Peripheral Component Interconnect (PCI) of a PCIe interface. The service interface 308 may be implemented using one or more PCI/PCIe instructions that interface with the storage device 108.

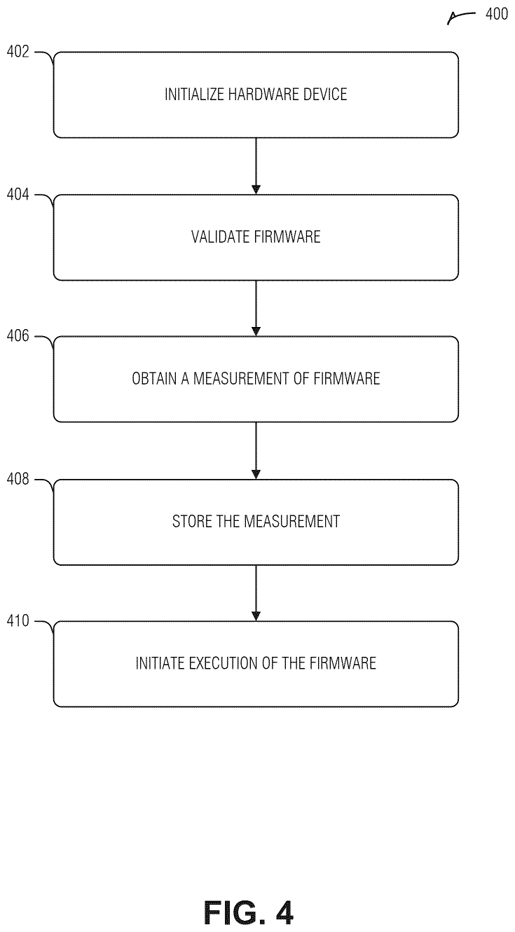

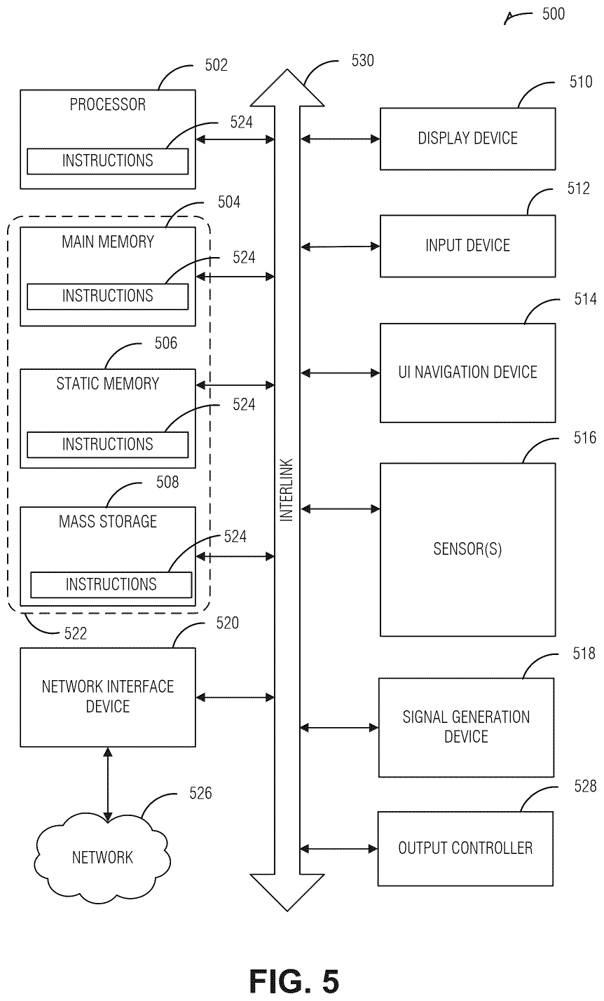

FIG. 4 is a flowchart illustrating an example method 400 for managing hardware-protected system measurements, according to an embodiment. The method 400 can be performed by processing logic that can include hardware (e.g., processing device, circuitry, dedicated logic, programmable logic, microcode, hardware of a device, integrated circuit, etc.). In various embodiments, the method 400 is performed by the secure boot ROM 202 or SOC 204 of FIG. 2, the secure boot ROM 302 or SOC 304 of FIG. 3, or the hardware processor 502 of FIG. 5.

The method 400 is for monitoring firmware on a hardware device capable of being installed on a host platform. In an embodiment, the method 400 is executed by a programmable read-only memory unit (e.g., secure boot ROM 202).

At operation 402, the hardware device is initialized. In an embodiment, initializing the hardware device comprises performing an integrity check of the hardware device. In another embodiment, initializing the hardware device comprises checking the memory device of the hardware device to ensure that it has been cleared.

At operation 404, firmware that is to execute on the hardware device is validated. In an embodiment, validating the firmware comprises fetching a firmware image of the firmware, the firmware image having a firmware signature and validating the firmware signature. In a further embodiment, the firmware image is a bootloader firmware image. In another embodiment, the firmware image is a device firmware image.

In a further embodiment, validating the firmware signature comprises executing a hash algorithm using at least a portion of the firmware image as input to the hash algorithm, the hash algorithm producing a hash, and comparing the hash to the firmware signature. In a further embodiment, comparing the hash to the firmware signature comprises obtaining a public key associated with a provider of the firmware image, decrypting the firmware signature with the public key to produce a decrypted hash, and comparing the hash to the decrypted hash.

At operation 406, a measurement of the firmware is obtained. In an embodiment, obtaining the measurement of the firmware comprises executing a hash algorithm on a portion of a firmware image of the firmware, to produce an unencrypted measurement. In a further embodiment, obtaining the measurement of the firmware comprises encrypting the unencrypted measurement to produce an encrypted measurement. The measurement may be encrypted using a private key of the device. Encrypted measurements may be decrypted using a public key provisioned to a host, where the public key is related to the private key of the device.

At operation 408, the measurement is stored in the memory device of the hardware device. In an embodiment, storing the measurement in the memory device comprises writing the measurement to a platform configuration register. In a further embodiment, the memory device is a hardware register.

At operation 410, execution of the firmware is initiated. In an embodiment, initiating execution of the firmware comprises initiating execution of a bootloader firmware image.

Although shown in a particular sequence or order, unless otherwise specified, the order of the methods or processes described herein can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

FIG. 5 illustrates a block diagram of an example machine 500 with which, in which, or by which any one or more of the techniques (e.g., methodologies) discussed herein can be implemented. Examples, as described herein, can include, or can operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 500.

In alternative embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can be a personal computer (PC), a tablet PC, a set-top box (STB), a personal digital assistant (PDA), a mobile telephone, a web appliance, a network router, switch or bridge, embedded memory controller, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 500 (e.g., computer system) can include a hardware processor 502 (e.g., a central processing unit (CPU), a graphics processing unit (GPU), a hardware processor core, or any combination thereof), a main memory 504, a static memory 506 (e.g., memory or storage for firmware, microcode, a basic-input-output (BIOS), unified extensible firmware interface (UEFI), etc.), and mass storage device 508 (e.g., hard drives, tape drives, flash storage, or other block devices) some or all of which can communicate with each other via an interlink 530 (e.g., bus). The machine 500 can further include a display device 510, an alphanumeric input device 512 (e.g., a keyboard), and a user interface (UI) Navigation device 514 (e.g., a mouse). In an example, the display device 510, the input device 512, and the UI navigation device 514 can be a touch screen display. The machine 500 can additionally include a mass storage device 508 (e.g., a drive unit), a signal generation device 518 (e.g., a speaker), a network interface device 520, and one or more sensor(s) 516, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 502, the main memory 504, the static memory 506, or the mass storage device 508 can be, or include, a machine-readable media 522 on which is stored one or more sets of data structures or instructions 524 (e.g., software) embodying or used by any one or more of the techniques or functions described herein. The instructions 524 can also reside, completely or at least partially, within any of registers of the hardware processor 502, the main memory 504, the static memory 506, or the mass storage device 508 during execution thereof by the machine 500. In an example, one or any combination of the hardware processor 502, the main memory 504, the static memory 506, or the mass storage device 508 can constitute the machine-readable media 522. While the machine-readable media 522 is illustrated as a single medium, the term “machine-readable medium” can include a single medium or multiple media (e.g., a centralized or distributed database, or associated caches and servers) configured to store the one or more instructions 524.

The term “machine readable medium” can include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 522 can be representative of the instructions 524, such as instructions 524 themselves or a format from which the instructions 524 can be derived. This format from which the instructions 524 can be derived can include source code, encoded instructions (e.g., in compressed or encrypted form), packaged instructions (e.g., split into multiple packages), or the like. The information representative of the instructions 524 in the machine-readable media 522 can be processed by processing circuitry into the instructions to implement any of the operations discussed herein. For example, deriving the instructions 524 from the information (e.g., processing by the processing circuitry) can include: compiling (e.g., from source code, object code, etc.), interpreting, loading, organizing (e.g., dynamically, or statically linking), encoding, decoding, encrypting, unencrypting, packaging, unpackaging, or otherwise manipulating the information into the instructions 524.

In an example, the derivation of the instructions 524 can include assembly, compilation, or interpretation of the information (e.g., by the processing circuitry) to create the instructions 524 from some intermediate or preprocessed format provided by the machine-readable media 522. The information, when provided in multiple parts, can be combined, unpacked, and modified to create the instructions 524. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 can be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is a system comprising: a memory device accessible by a first device and a host device, wherein the first device is configured for use with the host device; processing circuitry coupled to the memory device; and programmable read-only memory coupled to the memory device, the programmable read-only memory comprising instructions to: initialize the first device; validate firmware that is to execute on the first device; obtain a measurement of the firmware; store the measurement in the memory device; and initiate execution of the firmware.

In Example 2, the subject matter of Example 1 includes, wherein to initialize the first device, the programmable read-only memory is configured to perform an integrity check of the first device.

In Example 3, the subject matter of Examples 1-2 includes, wherein to initialize the first device, the programmable read-only memory is configured to check the memory device to ensure that it has been cleared.

In Example 4, the subject matter of Examples 1-3 includes, wherein to validate the firmware, the programmable read-only memory is configured to: fetch a firmware image of the firmware, the firmware image having a firmware signature; and validate the firmware signature.

In Example 5, the subject matter of Example 4 includes, wherein the firmware image is a bootloader firmware image.

In Example 6, the subject matter of Examples 4-5 includes, wherein the firmware image is a device firmware image.

In Example 7, the subject matter of Examples 4-6 includes, wherein to validate the firmware signature, the programmable read-only memory is configured to: execute a hash algorithm using at least a portion of the firmware image as input to the hash algorithm, the hash algorithm producing a hash; and compare the hash to the firmware signature.

In Example 8, the subject matter of Example 7 includes, wherein to compare the hash to the firmware signature, the programmable read-only memory is configured to: obtain a public key associated with a provider of the firmware image; decrypt the firmware signature with the public key to produce a decrypted hash; and compare the hash to the decrypted hash.

In Example 9, the subject matter of Examples 1-8 includes, wherein to obtain the measurement of the firmware, the programmable read-only memory is configured to execute a hash algorithm on a portion of a firmware image of the firmware, to produce an unencrypted measurement.

In Example 10, the subject matter of Example 9 includes, wherein to obtain the measurement of the firmware, the programmable read-only memory is configured to encrypt the unencrypted measurement to produce an encrypted measurement.

In Example 11, the subject matter of Examples 1-10 includes, wherein to store the measurement in the memory device, the programmable read-only memory is configured to write the measurement to a platform configuration register.

In Example 12, the subject matter of Example 11 includes, wherein the memory device is a hardware register.

In Example 13, the subject matter of Examples 1-12 includes, wherein to initiate execution of the firmware, the programmable read-only memory is configured to initiate execution of a bootloader firmware image.

Example 14 is a method of monitoring firmware on a hardware device capable of being installed on a host platform, the method executed by a programmable read-only memory unit, the method comprising: initializing the hardware device; validating firmware that is to execute on the hardware device; obtaining a measurement of the firmware; storing the measurement in a memory device of the hardware device; and initiating execution of the firmware.

In Example 15, the subject matter of Example 14 includes, wherein initializing the hardware device comprises performing an integrity check of the hardware device.

In Example 16, the subject matter of Examples 14-15 includes, wherein initializing the hardware device comprises checking the memory device of the hardware device to ensure that it has been cleared.

In Example 17, the subject matter of Examples 14-16 includes, wherein validating the firmware comprises: fetching a firmware image of the firmware, the firmware image having a firmware signature; and validating the firmware signature.

In Example 18, the subject matter of Example 17 includes, wherein the firmware image is a bootloader firmware image.

In Example 19, the subject matter of Examples 17-18 includes, wherein the firmware image is a device firmware image.

In Example 20, the subject matter of Examples 17-19 includes, wherein validating the firmware signature comprises: executing a hash algorithm using at least a portion of the firmware image as input to the hash algorithm, the hash algorithm producing a hash; and comparing the hash to the firmware signature.

In Example 21, the subject matter of Example 20 includes, wherein comparing the hash to the firmware signature comprises: obtaining a public key associated with a provider of the firmware image; decrypting the firmware signature with the public key to produce a decrypted hash; and comparing the hash to the decrypted hash.

In Example 22, the subject matter of Examples 14-21 includes, wherein obtaining the measurement of the firmware comprises executing a hash algorithm on a portion of a firmware image of the firmware, to produce an unencrypted measurement.

In Example 23, the subject matter of Example 22 includes, wherein obtaining the measurement of the firmware comprises encrypting the unencrypted measurement to produce an encrypted measurement.

In Example 24, the subject matter of Examples 14-23 includes, wherein storing the measurement in the memory device comprises writing the measurement to a platform configuration register.

In Example 25, the subject matter of Example 24 includes, wherein the memory device is a hardware register.

In Example 26, the subject matter of Examples 14-25 includes, wherein initiating execution of the firmware comprises initiating execution of a bootloader firmware image.

Example 27 is at least one machine-readable medium including instructions that, when executed by processing circuitry, cause the processing circuitry to perform operations to implement of any of Examples 1-26.

Example 28 is an apparatus comprising means to implement of any of Examples 1-26.

Example 29 is a system to implement of any of Examples 1-26.

Example 30 is a method to implement of any of Examples 1-26.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A system comprising:
a memory device accessible by a first device and a host device, wherein the first device is configured for use with the host device;
processing circuitry coupled to the memory device; and
programmable read-only memory coupled to the memory device, the programmable read-only memory comprising instructions to:
initialize the first device;
validate firmware that is to execute on the first device;
obtain a measurement of the firmware;
store the measurement in the memory device; and
initiate execution of the firmware.

2. The system of claim 1, wherein to initialize the first device, the programmable read-only memory is configured to perform an integrity check of the first device.

3. The system of claim 1, wherein to initialize the first device, the programmable read-only memory is configured to check the memory device to ensure that it has been cleared.

4. The system of claim 1, wherein to validate the firmware, the programmable read-only memory is configured to:
fetch a firmware image of the firmware, the firmware image having a firmware signature; and
validate the firmware signature.

5. The system of claim 4, wherein the firmware image is a bootloader firmware image.

6. The system of claim 4, wherein the firmware image is a device firmware image.

7. The system of claim 4, wherein to validate the firmware signature, the programmable read-only memory is configured to:
execute a hash algorithm using at least a portion of the firmware image as input to the hash algorithm, the hash algorithm producing a hash; and
compare the hash to the firmware signature.

8. The system of claim 7, wherein to compare the hash to the firmware signature, the programmable read-only memory is configured to:
obtain a public key associated with a provider of the firmware image;
decrypt the firmware signature with the public key to produce a decrypted hash; and
compare the hash to the decrypted hash.

9. The system of claim 1, wherein to obtain the measurement of the firmware, the programmable read-only memory is configured to execute a hash algorithm on a portion of a firmware image of the firmware, to produce an unencrypted measurement.

10. The system of claim 9, wherein to obtain the measurement of the firmware, the programmable read-only memory is configured to encrypt the unencrypted measurement to produce an encrypted measurement.

11. The system of claim 1, wherein to store the measurement in the memory device, the programmable read-only memory is configured to write the measurement to a platform configuration register.

12. The system of claim 11, wherein the memory device is a hardware register.

13. The system of claim 1, wherein to initiate execution of the firmware, the programmable read-only memory is configured to initiate execution of a bootloader firmware image.

14. A method of monitoring firmware on a hardware device capable of being installed on a host platform, the method executed by a programmable read-only memory unit, the method comprising:
initializing the hardware device;
validating firmware that is to execute on the hardware device;
obtaining a measurement of the firmware;
storing the measurement in a memory device of the hardware device; and
initiating execution of the firmware.

15. The method of claim 14, wherein initializing the hardware device comprises performing an integrity check of the hardware device.

16. The method of claim 14, wherein initializing the hardware device comprises checking the memory device of the hardware device to ensure that it has been cleared.

17. The method of claim 14, wherein validating the firmware comprises:
fetching a firmware image of the firmware, the firmware image having a firmware signature; and
validating the firmware signature.

18. The method of claim 17, wherein the firmware image is a bootloader firmware image.

19. The method of claim 17, wherein the firmware image is a device firmware image.

20. The method of claim 17, wherein validating the firmware signature comprises:
executing a hash algorithm using at least a portion of the firmware image as input to the hash algorithm, the hash algorithm producing a hash; and
comparing the hash to the firmware signature.
